(19) United States
(12) Patent Application Publication
(10) Pub. No.: US 2012/0314461 A1
(43) Pub. Date: Dec. 13, 2012

(54) POWER CONVERTER

(75) Inventors: Satoru YOSHIKAWA, Nishio-shi (JP); Seiji Iyasu, Anjo-shi (JP); Shinji Andou, Nukata-gun (JP); Shinji Ohoka, Okazaki-shi (JP); Jun Ishii, Okazaki-shi (JP)

(73) Assignee: DENSO CORPORATION, Kariya-city (JP)

(21) Appl. No.: 13/492,106

(22) Filed: Jun. 8, 2012

(30) Foreign Application Priority Data
Jun. 8, 2011 (JP) 2011-128376

(51) Int. Cl. H02M 1/12; H02M 7/44; H02M 7/04

(52) U.S. Cl. 363/40; 363/39; 363/44

(57) ABSTRACT

A power converter that is able to lower the level of switching noise in a wide frequency range is disclosed. In detail, the power converter converts an input power by controlling a switching element on the basis of a switching frequency discrete pattern. The switching frequency discrete pattern is composed in such a manner that a main discrete pattern and a sub discrete pattern are synthesized. The main discrete pattern is regulated by a plurality of transitionally discrete frequencies. Also the sub discrete pattern is regulated by a plurality of transitionally discrete frequencies in which a gap of the magnitude among consequent frequencies is smaller than that of the main discrete pattern.

### CROSS-REFERENCE TO RELATED APPLICATION

This application is based on and claims the benefit of priority from earlier Japanese Patent Application No. 2011-128376 filed Jun. 8, 2011, the description of which is incorporated herein by reference.

### BACKGROUND

1. Technical Field of the Invention

The present invention relates to a power converter which controls switching of a switching element by making the switching frequencies discrete.

2. Related Art

A patent document JP-B-3718830, for example, discloses such a power converter. In detail, the patent document discloses a signal generator, signal selecting means, voltage divider, comparator and switching element.

The signal generator generates a plurality of signals such that each signal frequency differs from other(s).

The signal selecting means sequentially selects and outputs signals of specified frequency in a predetermined order from among the plurality of signals generated by the signal generator. For example, the signal selecting means sequentially selects and outputs signals in ascending order among the plurality of signals generated by the signal generator, and after that, this manner of selection is repeatedly performed. Alternatively, the signal selecting means sequentially selects and outputs signals firstly in ascending order and after in descending order among the plurality of signals generated by the signal generator, and after that, this manner of selection is repeatedly performed. The voltage divider divides and outputs the voltage outputted from the power converter. The comparator compares the divided voltage outputted from the voltage divider with the signal outputted from the signal selecting means, and then outputs a switching signal according to the results of the comparison. The switching element conducts switching according to the switching signal outputted from the comparator.

Thus, the power converter according to the prior art controls switching of the switching element by making the switching frequencies discrete. Switching noise has its peaks at the switching frequency and at the frequency corresponding to harmonics of the switching frequency. The peaks of switching noise can be made spread within the frequency range by making the switching frequencies discrete. As the result, the energy of the switching noise is dispersed and thus the peak values of the switching noise become lowered. That is to say, the level of switching noise becomes lowered.

In the aforementioned power converter, even if the switching frequency is made discrete so as to lower the level of switching noise having frequency corresponding to low-degree harmonics, the level of switching noise having frequency corresponding to high-degree harmonics cannot be lowered. On the contrary, even if the switching frequency is made discrete so as to lower the level of switching noise having frequency corresponding to high-degree harmonics, the level of switching noise having frequency corresponding to low-degree harmonics. In this way, it has been a problem that lowering the level of switching noise in a low-frequency range cannot be inconsistent with lowering the level of switching noise in a high-frequency range.

In this way, it is difficult to achieve at the same time as lowering the level of switching noise in a low-frequency range and lowering the level of switching noise in a high-frequency range.

In light of the conditions set forth above, it is desired to provide a power converter which is able to lower the level of switching noise in a wide frequency range.

### SUMMARY

Then inventors hereby present a power converter which is able to lower the level of switching noise in a wide frequency range. In detail, the power converter converts an input power by controlling a switching element on the basis of a switching frequency discrete pattern. The switching frequency discrete pattern has such a manner that a main discrete frequency pattern and a sub discrete frequency pattern are synthesized. The main discrete frequency pattern has a plurality of transitionally discrete frequencies. Also the sub discrete frequency pattern has a plurality of discrete frequencies and a gap of the magnitude among consequent frequencies is smaller than that of the main discrete frequency pattern.

### BRIEF DESCRIPTION OF THE DRAWINGS

In the accompanying drawings:

FIG. 1 is a circuit diagram illustrating a power supply apparatus according to an embodiment of the present invention;

FIGS. 2(a), 2(b) and 2(c) are diagrams illustrating a main discrete pattern, a sub discrete pattern and a switching frequency discrete pattern, respectively;

FIGS. 3A and 3B are diagrams illustrating of the result of an analysis of switching noise conducted by a spectrum analyzer in the case where switching frequency is not made discrete and in the case where switching frequency is made discrete, respectively, according to prior art;

FIG. 3C is a diagram illustrating of the result of an analysis of switching noise conducted by a spectrum analyzer in the case where switching frequency is made discrete, according to the embodiment of the present invention;

FIG. 4A is a diagram illustrating a switching frequency discrete pattern, according to prior art;

FIG. 4B is a diagram illustrating of the result of an analysis of harmonic components included in inputted AC current, in the case where switching frequency is made discrete based on the switching frequency discrete pattern of prior art; and

FIG. 5 is a diagram illustrating of the result of an analysis of harmonic components included in inputted AC current, in the case where switching frequency is made discrete based on the switching frequency discrete pattern illustrated in FIG. 2(c).

### DETAILED DESCRIPTION OF THE PREFERRED EMBODIMENTS

The exemplary invention hereinafter will be described with reference to the accompanying drawings. As the embodiment, a power converter which converts AC power outputted from an external AC power source into DC power in order to charge a high-voltage battery mounted in a vehicle is disclosed.

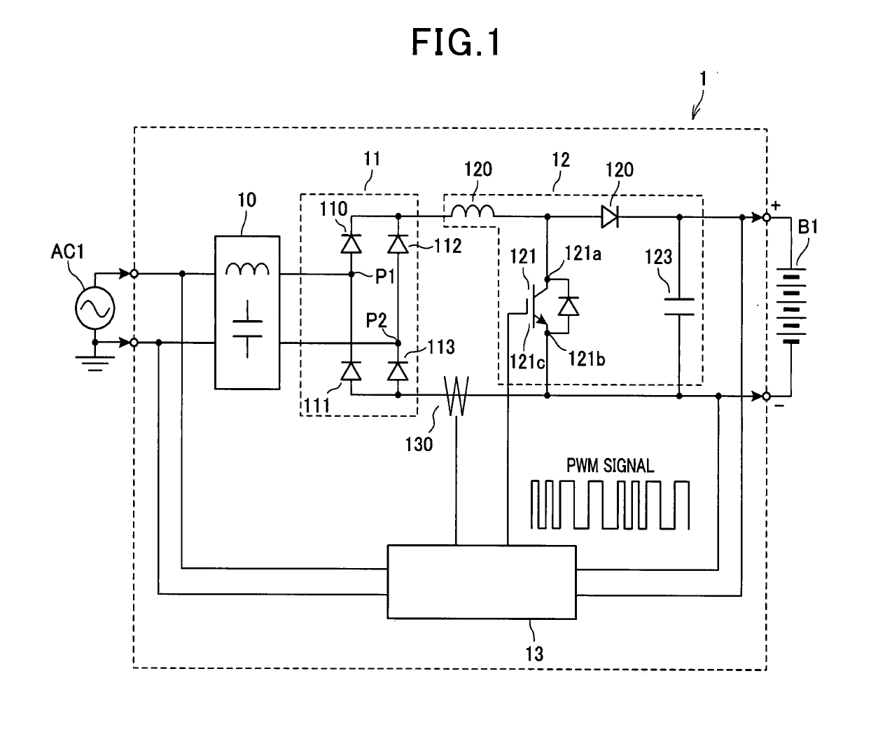

FIG. 1 is a circuit diagram illustrating a power converter 1 according to the exemplary embodiment.

The power converter 1 shown in FIG. 1 is applied for charging a high-voltage battery B1 mounted in a vehicle. In charging the high-voltage battery B1, the power converter 1 converts the AC voltage outputted from an external AC power source AC1 (external power source) into high DC voltage. The power converter 1 includes a filter circuit 10, rectifier circuit 11, booster circuit 12 and control circuit 13. Both the rectifier circuit 11 and the booster circuit consist of a power conversion circuit.

The filter circuit 10 removes noise from high-frequency components included in the AC voltage outputted from the external AC power source AC1. The filter circuit 10 is connected to the external AC power source AC1 by its input terminal and to the rectifier circuit 11 by its output terminal.

The rectifier circuit 11 rectifies the AC voltage being removed with the high-frequency components outputted from the filter circuit 10, and converts the rectified AC voltage into DC voltage. The rectifier circuit 11 includes diodes 110, 111, 112 and 113. The diodes 110 and 111 are mutually connected in series and the diodes 112 and 113 are also mutually connected in series.

In detail, as shown in FIG. 1, the cathode of the diodes 110 is connected to the cathode of the diodes 111, and the cathode of the diodes 112 is connected to the cathode of the diodes 113. Thus serially connected diodes 110 and 111 are connected in parallel with the serially connected diodes 112 and 113. Both cathodes of the diodes 110 and 112 and both anodes of the diodes 111 and 113 are respectively connected to the booster circuit 12. The connected point (P1) of diode 110 and 111 and the connected point (P2) of diode 112 and 113 are respectively connected to an output terminal of the filter circuit 10.

The booster circuit 12 boosts the DC voltage outputted from the rectifier circuit 11, i.e., the booster circuit 12 converts the inputted DC power into a high voltage DC power. The booster circuit 12 is provided with a coil 120, IGBT (insulated gate bipolar transistor as a switching element) 121, diode 122 and smoothing capacitor 123.

The coil 120 is an element that accumulates energy therein when AC current passes through there. One end of the coil 120 is connected to the cathodes of the diodes 110 and 112, and another end of the coil 120 is connected to the IGBT 121 and the diode 122.

The IGBT 121 is such an element as allows the coil 120 to accumulate energy therein or allows the coil 120 to discharge energy therefrom when switching is conducted. A corrector 121a of the IGBT 121 is connected to another end of coil 120, an emitter 121b of the IGBT is connected to the anodes of the diodes 111 and 113. Also, a gate 121c of the IGBT 121 is connected to the control circuit 13.

The diode 122 is supplies the energy discharged from the coil 120 to the smoothing capacitor 123 and prevents back flow. An anode of the diode 122 is connected to a connecting point between the coil 120 and the IGBT 121, and a cathode of the diode 122 is connected to the smoothing capacitor 123.

The smoothing capacitor 123 smoothes the boosted high DC voltage which appears at the cathode of the diode 122. One end of the smoothing capacitor 123 is connected to the cathode of the diode 122 and another end of the smoothing capacitor 123 is connected to the emitter of the IGBT 121. Further, one end of the smoothing capacitor 123 is connected to the positive (+) terminal of the high-voltage battery B1 and another end of the smoothing capacitor 123 is connected to the negative (−) terminal of the high-voltage battery B1.

The control circuit 13 controls the IGBT 121 so that the voltage outputted from the booster circuit 12 will become a predetermined target voltage. The control circuit 13 generates PWM (pulse width modulation) signals so as to make the value of the voltage outputted from the booster circuit 12 a target voltage, and controls switching of the IGBT 121 on the basis of the generated PWM signal. Specifically, the control circuit 13 makes the frequency of a PWM signals discrete according to a predetermined switching frequency discrete pattern, and determines a duty ratio of the PWM signal on the basis of the value of the target voltage, the value of the current inputted to the booster circuit 12 and the value of the voltage outputted from the booster circuit 12. Then, the control circuit 13 generates the PWM signal on the basis of a zero cross point of the AC voltage of the external AC power source AC1, and control switching of the IGBT 121 on the basis of the generated PWM signals.

In order to detect an input current to the booster circuit 12, the control circuit 13 is connected to a current sensor 130 disposed between the rectifier circuit 11 and the booster circuit 12. Also, in order to detect voltage outputted from the booster circuit 12, the control circuit 13 is connected to both terminals of the smoothing capacitor 123. Further, in order to detect the AC voltage of the external AC power source AC1, the control circuit 13 is connected to the input terminals of the filter circuit 10. In addition, the control circuit 13 is also connected to the gate 121c of the IGBT 121.

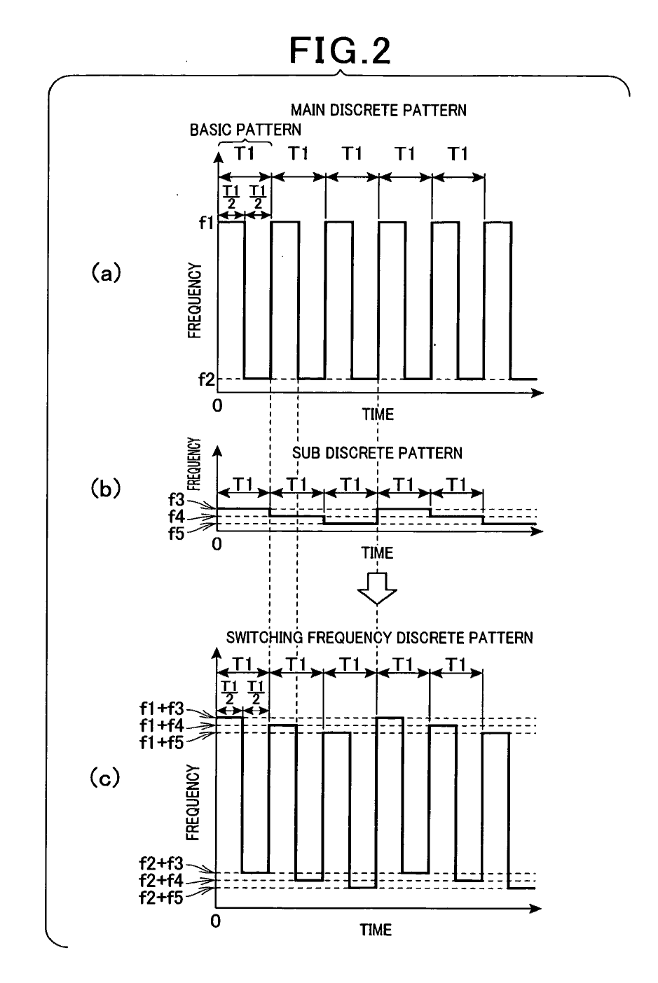

Next, the switching frequency discrete pattern is explained with reference to FIGS. 2(a), 2(b) and 2(c). FIGS. 2(a), 2(b) and 2(c), respectively shows a main discrete pattern, a sub discrete pattern and the switching frequency discrete pattern.

As shown in FIGS. 2(a), 2(b) and 2(c), the switching frequency discrete pattern is composed by synthesizing the main discrete pattern and one sub discrete pattern. As shown in FIG. 2(a), the main discrete pattern is composed so as to regulate two frequencies f1 and f2 (<f1). That is, the main discrete pattern is composed of repetitions of a basic pattern. The basic pattern repeats at intervals of time T1 (repetition time).

Specifically, it is so regulated that the frequency f1 is used for a time T1/2 and after then the frequency f2 is used for the following time T1/2. After that, this basic pattern repeats as the same manner.

As shown in FIG. 2(b), the sub discrete pattern is composed so as to transitionally regulate three frequencies f3, f4 (<f3) and f5 (<f4). Specifically, it is so regulated that the frequency f3 is for a time T1, after then the frequency f4 is for the consequent time T1 and after then the frequency f5 is for the time T1. After that, this sub discrete pattern repeats as the same manner.

Wherein, the sub discrete pattern is designed in such a manner that the gap of the magnitude between one frequency (e.g. f3) and consequent frequency (f4) is smaller than that of the main discrete pattern. As shown in FIG. 2(b), one can understand that the sub discrete pattern repeats at intervals of time 3×T1.

The frequencies of the main discrete pattern are set to be higher than the harmonics to be decreased among the harmonics of the frequency of the inputted AC current, preferably higher than the 40^{th} harmonics. The values of each frequency of the main discrete pattern and the sub discrete pattern are set in order that the interval of the adjacent harmonics of the switching frequency will be larger than a resolving power (bandwidth, and so forth) of a spectrum analyzer. Specifically, the frequency of the main discrete pattern is set in order that the interval of adjacent harmonics of the switching frequency will be larger than the resolving power of the spectrum analyzer at the frequency range where low-degree harmonics of the switching frequency are generated. The frequency of the sub discrete pattern is set in order that the interval of adjacent harmonics of the switching frequency will be larger than the resolving power of the spectrum analyzer at the frequency range where high-degree harmonics of the switching frequency are generated. For example, in a case that the maximum resolving power of the spectrum analyzer is limited to less than 9 kHz, the frequency of each of the patterns is set to higher than 9 kHz, preferably higher than 15 kHz.

Referring to FIG. 1 and FIGS. 2(a), 2(b) and 2(c), the operation of the power supply apparatus 1 is hereinafter explained.

In FIG. 1, the rectifier circuit 11 rectifies the AC voltage from which high-frequency noise components have been removed, outputted from the filter circuit 10, for conversion into DC voltage. The control circuit 13 makes the frequency of a PWM signal discrete according the switching frequency discrete pattern shown in FIG. 2(c).

At the same time, the control circuit 13 determines a duty ratio of the PWM signal based on the target voltage, the current inputted to the booster circuit 12 and the voltage outputted from the booster circuit 12. Then, the control circuit 13 generates the PWM signal on the basis of a zero cross point of the AC voltage of the external AC power supply AC1. The IGBT 121 conducts switching based on the PWM signal generated by the control circuit 13, and allows the coil 120 to accumulate energy therein or to discharge energy therefrom. The energy discharged from the coil 120 is outputted via the diode 122 and smoothed by the smoothing capacitor 123. Thus, the booster circuit 12 boosts the DC voltage outputted from the rectifier circuit 11 up to the target voltage, for supply to the high-voltage battery B1 to thereby charge the high-voltage battery B1.

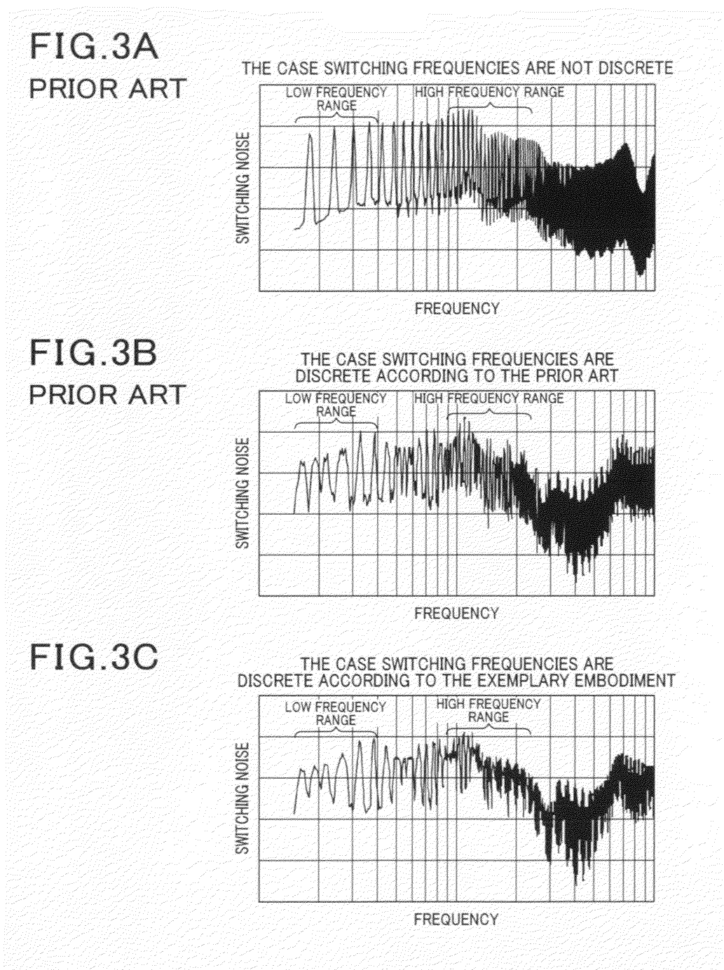

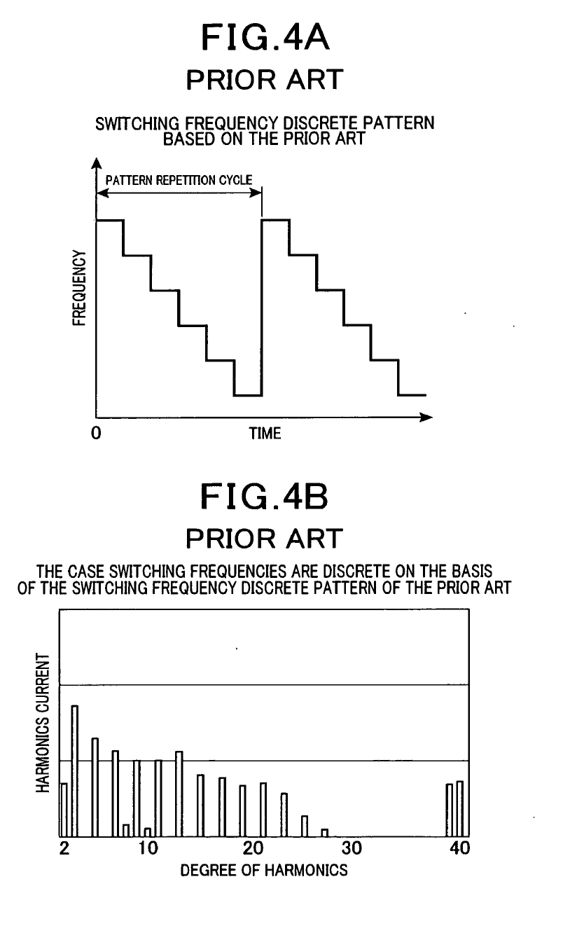

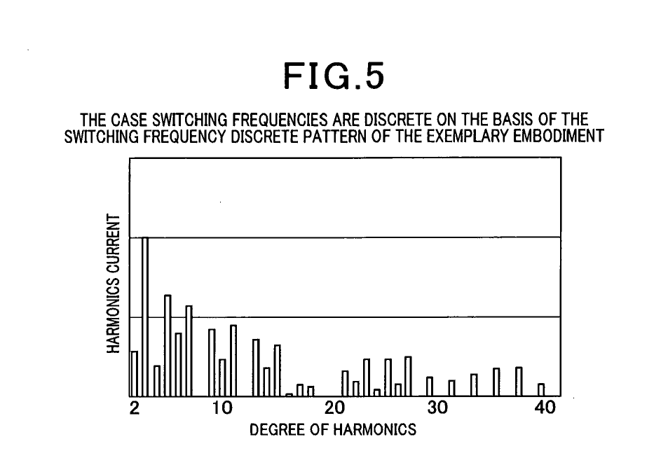

Next, advantages of the power converter 1 of the exemplary embodiment are hereinafter explained with reference to FIGS. 2(a), 2(b) and 2(c), FIGS. 3A, 3B and 3C, FIGS. 4A and 4B, and FIG. 5. FIGS. 3A, 3B and 3C show analysis results of switching noise by a spectrum analyzer. FIGS. 3A shows a case that switching frequencies are not discrete, FIGS. 3B shows a case that switching frequencies are discrete according to prior art, and FIGS. 3C shows a case that switching frequencies are discrete according to the exemplary embodiment. FIG. 4A shows a switching frequency discrete pattern based on prior art. FIG. 4B shows an analysis result of harmonic components included in the inputted AC current in the case that switching frequencies are discrete on the basis of the switching frequency discrete pattern of the prior art as shown in FIG. 4A. FIG. 5 shows an analysis result of harmonic components included in the inputted AC current in the case that switching frequencies are discrete on the basis of the switching frequency discrete pattern of this embodiment as shown in FIG. 2(c).

In the case where switching frequencies are not discrete, high level switching noise appears, as shown in FIG. 3A, within the range from low frequency to high frequency. In the case switching frequencies are discrete according to the prior art, switching noise are made to lower level, as shown in FIG. 3B, within the range of low frequency. However, in this case, switching noise is not lowered within the range of high frequency.

In this regard, as shown in FIGS. 2(a) to 2(c), the switching frequency discrete pattern of the exemplary embodiment is composed by synthesizing the main discrete pattern and one sub discrete pattern.

According to the present invention, using the main discrete pattern switching frequency, the level of switching noise is made to be even lower, as shown in FIG. 3C, within the range of low-frequency.

Further, using the sub discrete pattern, peaks of switching noise can be evidently discrete at the frequency corresponding to harmonics of the switching frequency. That is, the level of switching noise is made lower within the range of high frequency as well. Accordingly, the power converter 1 which converts AC power outputted from the external AC power source AC1 into DC power for charging the high-voltage battery B1 mounted in a vehicle can make the level of switching noise lower in a wide frequency range. As a result, the power converter 1 can reduces the influences of the switching noise against other devices within the vehicle when the power converter 1 is charging the high-voltage battery B1.

According to the exemplary embodiment, as shown in FIG. 2(a), the main discrete pattern is composed by repetitions of the basic pattern, at the intervals of time T1, such that the two frequencies f1 and f2 are regulated. Also, as shown in FIG. 2(b), in the sub discrete pattern, three frequencies f1˜f3 are switched at the interval of time T1. Accordingly, peaks of switching noise are more evidently discrete at the frequency corresponding to harmonics of the switching frequency.

Further, according to the exemplary embodiment, each one of the frequencies included in the main discrete pattern is set in order that the interval of adjacent harmonics of the switching frequency will be larger than the resolving power of the spectrum analyzer at the region where lower-degree harmonics of the switching frequency are generated. Also, the frequency of the sub discrete pattern is set in order that the interval of adjacent harmonics of the switching frequency will be larger than the resolving power of the spectrum analyzer at the region where high-degree harmonics of the switching frequency are generated. Thus, when the switching noise is analyzed by the spectrum analyzer, the effect by using the main discrete pattern and the sub discrete patterns are correctly analyzed.

When one makes the switching frequencies discrete on the basis of the switching frequency discrete pattern of the prior art as shown in FIG. 4A, the value of the harmonic components included in the AC current inputted to the filter circuit 10 becomes high as shown in FIG. 4B. This is because, the frequency components included in the switching frequency discrete pattern (i.e. the repetition frequency which is an inverse of a repetition cycle of the switching frequency discrete pattern) superimpose over the inputted AC current and causes distortion therein. For example, in a case where the repetition frequency of the switching frequency discrete pattern is about 2 kHz, the intensity of the harmonic components near the 40^{th} harmonics becomes high. However, according to the exemplary embodiment, a switching frequency discrete pattern is composed of the main discrete pattern and one sub discrete pattern (as shown in FIG. 2(c)), thereby the manner of discreteness of the switching frequencies is specialized. Then, as shown in FIG. 5, the value of harmonic components included in the inputted AC current is made lower. This is because, by changing of the manner of discreteness of the switching frequencies, frequency components included in the switching frequency discrete pattern are made to change, and still more the influence on the inputted AC current is also made to change. According to FIGS. 2(a), 2(b) and 2(c), one will be able to understand that the switching frequency discrete pattern includes both the repetition frequency which is an inverse of the repetition cycle (T1) of the basic pattern in the main discrete pattern and the repetition frequency which is an inverse of the repetition cycle (3×T1) of the sub discrete pattern. Further, one will be able to understand, according to FIG. 2(b) and FIG. 2(c), the repetition frequency (1/(3×T1)) of the sub discrete pattern corresponds with the repetition frequency of the switching frequency discrete pattern. In this case, the frequency superimposed over the inputted AC current is more dominated by the repetition frequency (1/T1) of the main discrete pattern than by the repetition frequency (1/(3×T1)) of the sub discrete pattern. Therefore, by adjusting the repetition frequency (1/T1) of the main discrete pattern, the level of harmonic components to be reduced among the harmonic components included in the inputted AC current is made to lower. Especially in the case where the repetition frequency (1/T1) of the main discrete pattern is set higher than 40 times of the frequency of the inputted AC current, the value of the frequency of the 40^{th} harmonic components is made to be sufficiently lowered. Still more, in the case where the repetition frequency (1/T1) of the main discrete pattern is set to a much higher value, the value of the frequency of the harmonic included in the inputted AC current is also shifted to a much higher level. As a result, removing measurement of the harmonic components is easily taken, and one can make the size of the filter circuit 10 compact.

Above-mentioned embodiment exemplifies that the inputted AC power is converted into DC power. However, the present invention is not limited to this manner. The present invention may be applied to such a converter that converts the inputted DC power into AC power. In this case, the level of harmonic components included in the outputted AC current may also be lowered. That is, the present invention may be widely applied to such a power converter that converts the inputted power by switching a switching element. According to the present invention, the level of switching noise may be lowered over a wide frequency range.

Further, afore-mentioned embodiment exemplifies that the main discrete pattern includes two transitional frequencies such as fl and f2 and the sub discrete pattern includes three transitional frequencies such as f3, f4 and f5. However, the present invention shall not be limited to this. The main discrete pattern and the sub discrete pattern respectively may be composed in such a manner that a plurality of transitional frequencies is included. Further, the manner of changing frequency is not limited to ascending or descending order. Random change is permitted.

The above-mentioned embodiment exemplifies that the switching frequency discrete pattern is composed by synthesizing the main discrete pattern and only one sub discrete pattern. However, present invention shall not be limited to this. The switching frequency discrete pattern may be composed by synthesizing the main discrete pattern and two or more sub discrete patterns. The switching frequency discrete pattern may have at least one sub discrete pattern.

In addition, above-mentioned embodiment exemplifies that the frequency of the main discrete pattern is set to higher than the harmonics to be reduced among the harmonics of the inputted AC current. However, the present invention shall not be limited to this. That is, in the case the power converter 1 outputs AC power by converting inputted DC power, the frequency of the main discrete pattern may be set to higher than the harmonics to be reduced among the harmonics of the outputted AC current. According to this, the harmonic components to be reduced included in the outputted AC current can be efficiently reduced.

What is claimed is:

1. A power converter which converts an inputted power by controlling a switching element on the basis of switching frequency discrete pattern comprising;
the switching frequency discrete pattern composed in such a manner that a main discrete pattern and a sub discrete pattern are synthesized,
wherein the main discrete pattern consists of a plurality of transitionally discrete frequencies, and
wherein the sub discrete pattern consists of a plurality of transitionally discrete frequencies such as the gap of the magnitude between one frequency and consequent frequency is smaller than that of the main discrete pattern.

2. A power converter according to claim 1, wherein the main discrete pattern repeats a basic pattern at the interval of a repetition time T1 and the sub discrete pattern changes frequency at the interval of the time T1.

3. A power converter according to claim 1, wherein the frequency included in the main discrete pattern and the sub discrete pattern is set up in order that a distance between adjoining harmonics in a switching frequency would be larger than a resolving power of a spectrum analyzer used for analysis of the power converter.

4. A power converter according to claim 2, wherein the frequency included in the main discrete pattern and the sub discrete pattern is set up in order that a distance between adjoining harmonics in a switching frequency would be larger than a resolving power of a spectrum analyzer used for analysis of the power converter.

5. A power converter according to claim 1, wherein the power converter outputs DC power by converting inputted AC power.

6. A power converter according to claim 2, wherein the power converter outputs DC power by converting inputted AC power.

7. A power converter according to claim 3, wherein the power converter outputs DC power by converting inputted AC power.

8. A power converter according to claim 1, wherein the power converter outputs AC power by converting inputted DC power.

9. A power converter according to claim 2, wherein the power converter outputs AC power by converting inputted DC power.

10. A power converter according to claim 3, wherein the power converter outputs AC power by converting inputted DC power.

11. A power converter according to claim 3, wherein a repetition frequency that is a reciprocal of a repetition time of the main discrete pattern is higher than the target harmonics in a frequency of inputted current or outputted current.

12. A power converter according to claim 4, wherein a repetition frequency that is a reciprocal of a repetition time of the main discrete pattern is higher than the target harmonics in a frequency of inputted current or outputted current.

13. A power converter according to claim 1, wherein the power converter supplies the DC power, by converting AC power inputted from an external power source, to a battery mounted in a vehicle.

14. A power converter according to claim 2, wherein the power converter supplies the DC power, by converting AC power inputted from an external power source, to a battery mounted in a vehicle.

15. A power converter according to claim 3, wherein the power converter supplies the DC power, by converting AC power inputted from an external power source, to a battery mounted in a vehicle.
